(19) United States
(12) Patent Application Publication
(10) Pub. No.: US 2022/0405813 A1
(43) Pub. Date: Dec. 22, 2022

(54) PRICE COMPARISON AND ADJUSTMENT APPLICATION

(71) Applicant: PalletOne, Inc., Bartow, FL (US)

(72) Inventors: Vilakone Champavannarth, Bartow, FL (US); Robert Modrall, Bartow, FL (US); Charles T. Staniek, Bartow, FL (US)

(73) Assignee: PalletOne, Inc., Bartow, FL (US)

(21) Appl. No.: 17/348,947

(22) Filed: Jun. 16, 2021

(51) Int. Cl. G06Q 30/02

(52) U.S. Cl. CPC G06Q 30/0283

(57) ABSTRACT

Computer-implemented price comparison and price adjustment recommendation methods, systems, and computer-readable media are described.

### FIELD

Some implementations are generally related to computerized price comparison and price adjustment applications and, in particular, to a price comparison application configured to automatically retrieve and compare prices of non-identically identified items based on a predetermined item correlation within a geographic area.

### BACKGROUND

Retailers often rely on suppliers to assist with pricing recommendations regarding items that have similar or identical counterpart items sold by competitors. Such pricing recommendations can help ensure that a given retailer's pricing on such items in a store remains competitive with competitors in the geographic area of the store.

Pricing recommendations can be difficult to formulate because items may be non-identically identified. For example, store brand items at two different retailers may be similar and/or functionally the same item but have different SKUs, barcode numbers, brand names, product names, etc. Thus, basing a price comparison on SKU or barcode number may be of little or no use when seeking to provide support for price recommendations on these non-identically identified items that may be, in actuality, similar or the same items.

Some implementations were conceived in light of the above-mentioned problems.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method. The method can include obtaining a selection of a first entity and a second entity at a user device and receiving first item information corresponding to a first item being sold by the first entity, wherein the first item information includes a first item identifier, first item price, and first item quantity at a first entity store location. The method can further include automatically correlating the first item identifier with a second item identifier associated with a second item that is a non-identically identified item being sold by the second entity that is identical to the first item and automatically obtaining second item information corresponding to the second item identifier, where the second item information includes a second item identifier, a second item price, and a second item quantity at a second entity store location.

The method can also include displaying the first item information and the second item information juxtaposed in a single user interface display and, in response to selection of a first user interface element, automatically generating a price adjustment recommendation and causing the price adjustment recommendation to be displayed. The method can further include, in response to selection of a second user interface element, automatically adjusting the price of the first item by sending an electronic message to adjust the price of the first item to a system associated with the first entity and in response to selection of third user interface element, automatically generating an electronic message including at least one of price comparison information or automatically generated price adjustment suggestion and causing the electronic message to be transmitted.

In some implementations, the automatically generated price adjustment recommendation includes one of a price adjustment recommendation to match the first item price with the second item price, a price adjustment recommendation to maintain the first item price a given amount or percentage below the second item price, or a price adjustment recommendation to maintain the first item price above the second item price. In some implementations, automatically adjusting the price of the first item includes one of matching the second item price, maintaining the first item price a given amount or percentage below the second item price, or maintaining the first item price above the second item price.

In some implementations, the second item is an item for which a SKU, a bar code, or other product identifier of the second item does not match a corresponding SKU, bar code, or other product identifier of the first item.

The method can also include performing a price comparison between the price of the first item at the first entity and the price of the second item at the second entity, where the first entity is associated with the user. In some implementations, the user is associated with a supplier to the first entity and the second entity is a retail competitor of the first entity.

In some implementations, the user can perform a price comparison and price adjustment based on price information from the first entity and the second entity. In some implementations, the selection of the first entity and the second entity can be determined based on a given geographic area. In some implementations, the first entity selection can be set in the settings and the second entity is selected by the user from one or more nearby entities that are presented to the user based on the location of the user device or a location entered by a user.

In some implementations, the second entity can include more than one entity. In some implementations, the user device communicates with a price comparison server to request matching information of the second item at the second entity corresponding to an item number or a barcode number of the first item.

In some implementations, the matching information includes one or more of manually matched non-identically identified identical products or automatically matched non-identically identified identical products. In some implementations, the matching information of the second item includes one or more of a barcode number, an item number, or other information used by the second entity to identify the non-identically identified identical product.

In some implementations, automatically obtaining second item information includes the user device or a server accessing a publicly available source of information to automatically obtain electronic information that indicates a current price and other information related to the second item for which price comparison is being performed.

The method can further include extracting one or more of price or quantity information from a website of the second entity and providing the price or quantity information for display to the user. In some implementations, price and quantity information of the second item is obtained through an API in communication with an ecommerce website, or by accessing competitor data that has been manually or automatically entered.

In some implementations, the price adjustment can be an automatically generated adjustment or a manually input adjustment. In some implementations, if the first entity and the second entity have the same quantities on hand of the first item and second item respectively, and if a price of the first item at the first entity is higher than the price of the second item form the second entity, the automatically generated price adjustment recommendation is to match or be lower than the second item price at the second entity.

In some implementations, if the quantity of the second item at the second entity is lower than the quantity of the first item at the first entity or zero and the price of the second item is lower than the price of the first item at the first entity, the automatically generated recommendation is to keep the price the same or increase the price of the first item at the first entity.

### BRIEF DESCRIPTION OF THE DRAWINGS

FIG. 1 is a block diagram of an example system and a network environment which may be used for one or more implementations described herein.

FIG. 2 is a diagram of an example user interface of a price comparison application showing a log in screen in accordance with some implementations.

FIG. 3 is a diagram of an example user interface of a price comparison application showing an item entry mode selection screen in accordance with some implementations.

FIG. 4 is a diagram of an example user interface of a price comparison application showing an item barcode entry screen in accordance with some implementations.

FIG. 5 is a diagram of an example user interface of a price comparison application showing a price comparison result screen in accordance with some implementations.

FIG. 6 is a flowchart of an example price comparison method for non-identically identified similar or identical items in accordance with some implementations.

FIG. 7 is a block diagram of an example computing device configured for one or more implementations described herein.

### DETAILED DESCRIPTION

Some implementations include price comparison, price adjustment recommendations, and non-identically identified item matching methods and systems.

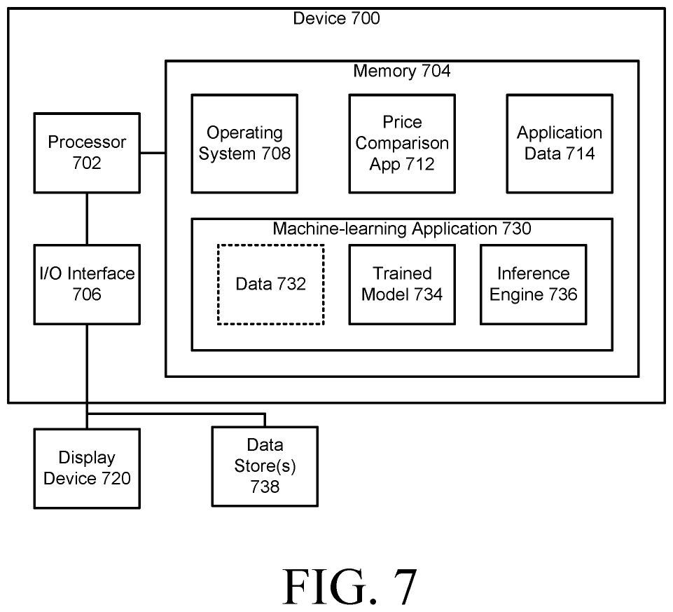

When performing price comparison and price adjustment recommendation functions, it may be helpful for a system to suggest a price adjustment and/or to make predictions about effects of a price adjustment in terms of sales volume, for example. To make predictions or suggestions, a probabilistic model (or other model as described below in conjunction with FIG. 7) can be used to make an inference (or prediction) about aspects of price adjustments such as predicted sales change. Accordingly, it may be helpful to make an inference regarding a probability that a price adjustment will result in continued or improved sales levels. Other aspects can be predicted or suggested as described below.

The inference based on the probabilistic model can include predicting a match between non-identically identified identical (or functionally identical) products in accordance with image (or other product data such as specifications or description) analysis and confidence score as inferred from the probabilistic model. The probabilistic model can be trained with data including previous non-identically identified identical product and matching data. Some implementations can include generating matching prediction based on non-identically identified identical product data such as images, specifications, and/or descriptions.

The systems and methods provided herein may overcome one or more deficiencies of some conventional price comparison systems and methods. For example, some conventional price comparison systems may not provide accurate price comparison information for non-identically identified identical products. As used herein non-identically identified identical products can include products that are identical, similar, or functionally identical, but have different identification information such as brand names, SKUs, bar code numbers, etc. among retailers.

The example systems and methods described herein may overcome one or more of the deficiencies of conventional price comparison systems to provide users with automated non-identically identified identical product matching. A technical problem of some conventional price comparison systems may be that such systems do not suggest or provide price comparison for non-identically identified identical products and/or predict a price adjustment recommendation for such products. In conventional price comparison systems, comparisons may need to be made based on matching SKUs, bar codes, or other product identifiers.

Particular implementations may realize one or more of the following advantages. An advantage of providing a price comparison and/or price adjustment recommendation on non-identically identified identical products based on methods and system described herein is that the suggestions are based on non-identically identified identical product data and confidence. Yet another advantage is that the methods and systems described herein can dynamically learn new thresholds (e.g., for confidence scores, etc.) and provide suggestions for making price comparisons, making price adjustment recommendations, and/or matching non-identically identified identical products that match the new thresholds. The systems and methods presented herein can automatically provide price adjustment recommendations suggestions that are more likely to be accepted by users and that likely are more accurate.

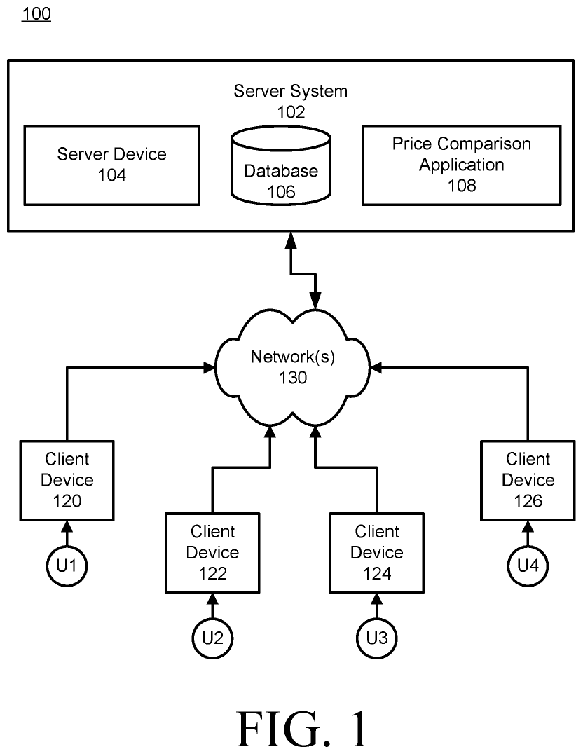

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104 and a database 106 or other data store or data storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., portable bar code scanner equipped device, desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide price comparisons, price adjustment recommendations, and/or non-identically identified identical product matching predictions.

Various implementations of features described herein can use any type of system and/or service. Any type of electronic device can make use of features described herein. Some implementations can provide one or more features described herein on client or server devices disconnected from or intermittently connected to computer networks.

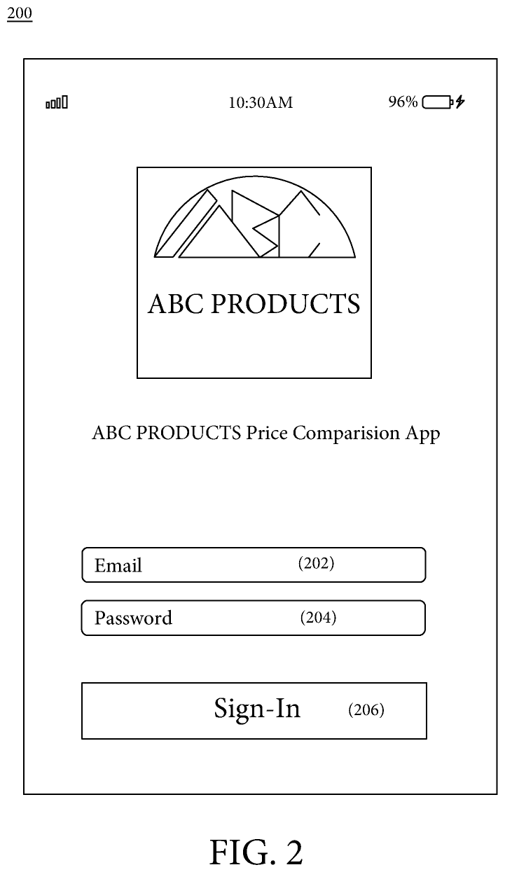

FIG. 2 is a diagram of an example user interface of a price comparison application showing a user authentication screen 200 in accordance with some implementations. The user authentication screen 200 includes an element for entering username 202 and password 204. The screen 200 also includes an element 206 (e.g., a button) that, when pressed or selected, initiates user authentication, which can occur on the user device (e.g., client device), at a server, or both.

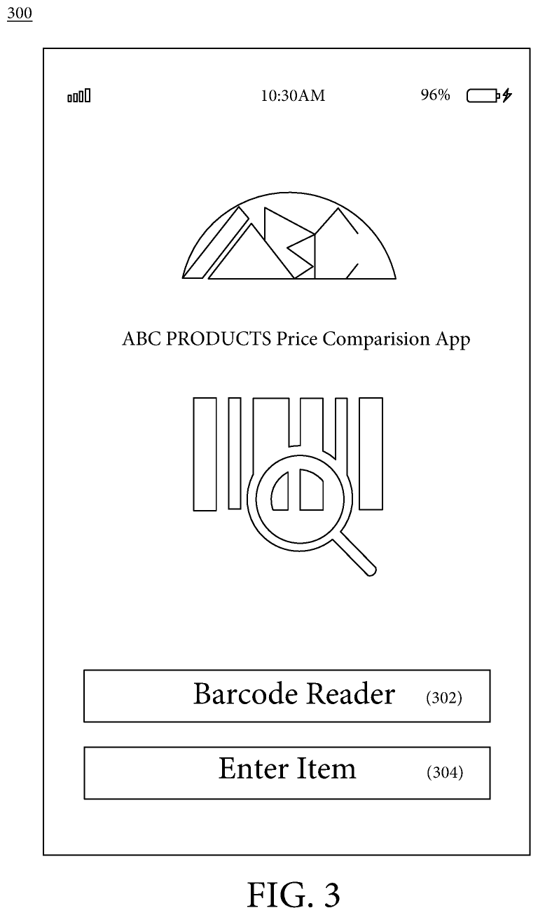

FIG. 3 is a diagram of an example user interface of a price comparison application showing an item entry mode selection screen 300 in accordance with some implementations. Once a user has been authenticated, the item entry mode selection screen 300 can be displayed. The item entry mode selection screen 300 includes elements for selecting bar code scanner 302 or manual item entry 304.

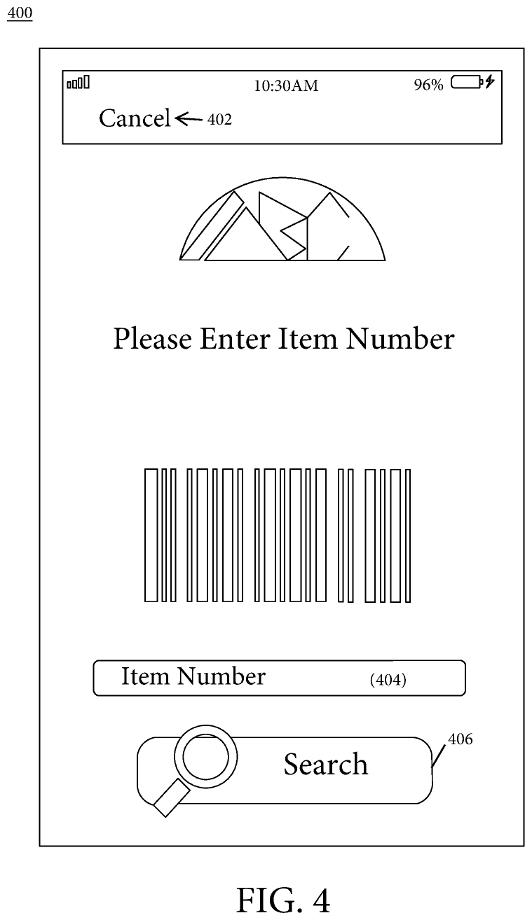

FIG. 4 is a diagram of an example user interface of a price comparison application showing an item entry screen 400 for permitting a user to enter a barcode or other item identifier in accordance with some implementations. The item entry screen 400 includes a cancel button 402 to return to the previous screen (e.g., screen 300 discussed above), an item number (or other identifier) entry element 404 and an element to initiate search 406. In another screen not shown due to difficulty presenting it in drawing form, a barcode scanner screen could be displayed that permits a user to capture a barcode with an imaging device (e.g., camera) of a mobile phone running the price comparison app or a scanner on a device with a barcode scanner running the price comparison app.

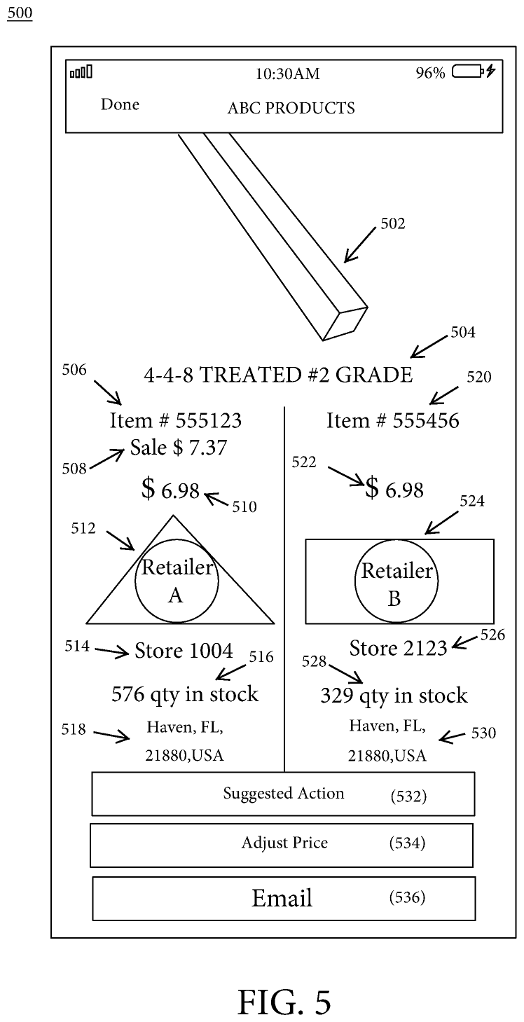

FIG. 5 is a diagram of an example user interface of a price comparison application showing a price comparison result screen 500 in accordance with some implementations. The result screen 500 is displayed once the item matching and competitive price (or prices), as discussed below, have been performed.

The price comparison can be performed between a first entity's price and one or more other entities (e.g., a second entity's) price. The first entity can be a retailer associated with the user. For example, the user can be associated with a supplier to the first entity. The other entities such as the second entity can be, for example, a retail competitor of the first entity retailer. The user can perform price comparison and, optionally, price adjustment or change, based on the price comparison information from the first entity and the second entity (or other entities).

The price comparison result screen 500 can include a representative product image 502, which can be retrieved from a product database of the first entity, for example. The price comparison result screen 500 can also include a name of the product 504, which can be a standard name of the product (e.g., a generic descriptor such as the example of a 4×4×8 treated #2 grade post as shown in FIG. 5). The price comparison result screen 500 can also include, from a first entity (e.g., “Retailer A”), an item number 506, a regular price 508, a current (or sale) price 510, entity identifier 512, store number 514, in stock quantity 516, and store location 518.

The price comparison result screen 500 also includes, for the second entity (e.g., “Retailer B”), an item number 520, a current (or sale) price 522, an entity identifier 524, store number 526, in stock quantity 528, and store location 530.

The price comparison result screen 500 can also include an optional suggested action element 532 that, when selected or activated, provides the user with a suggested action based on the price comparison data such as current prices, current in stock quantities, store locations, etc. The suggested action could include one of lowering the price at the first entity, keeping the price the same at the first entity, or raising the price at the first entity. For example, if the first entity and the second entity have the same quantities on hand of the item, but the first entity price is higher, the recommendation may be to match or be lower (e.g., by a given percentage or fixed amount) the price of the item at the first entity. However, in another example, if the quantity of the item at the second entity is low or zero and the price is lower than the price of the item at the first entity, the automatically generated recommendation may be to keep the price the same or increase the price of the item at the first entity because of item scarcity in the area. The automatically generated suggestion can be based on both price and quantity (or other factors). The suggested action could be generated from a machine learning model as discussed herein.

The price comparison result screen 500 can also include an optional adjust price element 534, which can be selected or activated to perform a price adjustment (manually or automatically) on the price of the item at the first entity store location. The price comparison and adjustment application can be configured to communicate with a system at the first entity to transmit the price adjustment information.

The price comparison result screen 500 can also include an optional email element 536 that when selected or activated causes an email to be automatically generated for sending price comparison and or price adjustment (manual or automatically generated). The email can go to a person at the first entity such as a store manager and/or other personnel to inform the person(s) of the price comparison and price adjustment, if included.

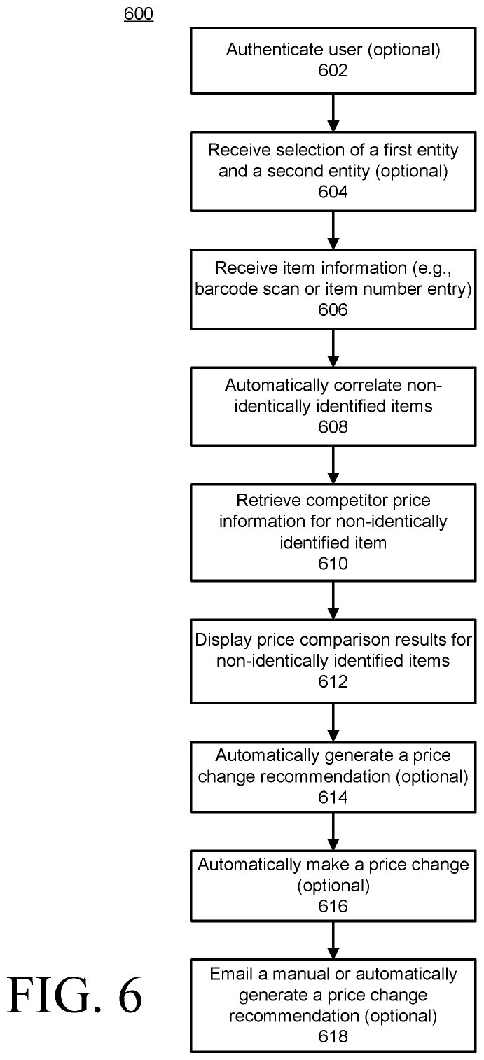

FIG. 6 is a flowchart of an example price comparison method 600 for non-identically identified similar or identical items in accordance with some implementations. Processing begins at 602 where a user is authenticated (e.g., using an authentication scree such as 200 described above). Processing continues to 604, if the user was authenticated. Otherwise, processing continues at 602.

At 604, a selection of a first entity and a second entity are optionally received or accessed. For example, in some implementations, the first entity and the second entity can be settings that a user has set and stored with the price comparison application so that the same two entities are used until the settings are changed. In some implementations, the selection of first entity and second entity can be selected by a user from among nearby entities in a given geographic area. In another example, in some implementations, the first entity can be set in the settings or preselected by the user and the second entity can be chosen from nearby entities that are presented to the user based on the location of the user device or based on some other location data (e.g., a location entered by a user). The second entity can include more than one entity (e.g., more than one competing retailer to compare with the first entity). Processing continues to 606.

At 606, item information is received. For example, an item number or barcode number can be entered (e.g., using screen 400) or a bar code can be scanned using the user device. This item number or barcode number is the number associated with the item at the first entity. Processing continues to 608.

At 608, the item number or barcode number of the product is automatically correlated to a non-identically identified identical product at the second entity. For example, the user device executing the price comparison application can communicate with a price comparison server to request matching information of the product at the second entity corresponding to the item number or barcode number of the product at the first entity. The matching data at the server can include manually matched non-identically identified identical products or automatically matched non-identically identified identical products (e.g., matched using a machine learning model as described herein or the like). The matching product information at the second entity can include the barcode number, item number, or other information used by the second entity to identify the non-identically identified identical product. For example, as shown in FIG. 5, the first entity has an item number for the product of 555123 (see 508) and the second entity has an item number of 555456 (see 520). Processing continues to 610.

At 610, price and other information (e.g., quantity on hand or sale price) are retrieved from the second entity using the matching information correlated at 608 above. For example, in some implementations, the retrieval can include the user device and/or the server accessing a publicly available source of information (e.g., the website of the second entity) to automatically obtain electronic information that indicates the current price and other information related to the product(s) for which price comparison is being performed. The price comparison client application or server application can extract (or “scrape”) price, quantity, and/or other information from the website of the second entity and provide the information to the price comparison application for display to the user (e.g., in a user interface screen such as FIG. 5).

The price and quantity information can also be obtained in other ways such as through an API with an ecommerce website, by accessing competitor data that has been manually or automatically entered, or by any other suitable method. Processing continues to 612.

At 612, price comparison information including price, quantity and other information for one or more products from the first and second entities is displayed. For example, the price comparison information can be displayed in a user interface screen such as that shown in FIG. 5. Processing continues to 614.

At 614, a price adjustment recommendation is optionally automatically generated as part of the price comparison process or in response to user input (e.g., selection of 532 in FIG. 5 discussed above). For example, a machine learning model can automatically generate a price adjustment recommendation based on the model and training data as discussed herein. Other automatic price adjustment techniques can be used as well such as price matching (e.g., to match a competitor's price, maintaining a price a given dollar amount or percentage below a competitor's price, having the highest price, etc.). The price adjustment recommendation can be displayed on the user device. Processing continues to 616.

At 616, the system can optionally make a price adjustment automatically according to a price adjustment technique as discussed above at 614, or in response to user input (e.g., selection of element 534 in FIG. 5 discussed above). The price adjustment can be an automatically generated adjustment or a manually input adjustment. Processing continues to 618.

At 618, a manually input or automatically generated price adjustment is optionally emailed in response to user input (e.g., selection of element 536 in FIG. 5 as discussed above). The price adjustment email can be sent to personnel at the first entity (e.g., a store manager or other store employee) and/or can be sent to the company or organization performing the price comparison.

FIG. 7 is a block diagram of an example device 700 which may be used to implement one or more features described herein. In one example, device 700 may be used to implement a client device, e.g., any of client devices 120-126 shown in FIG. 1. Alternatively, device 700 can implement a server device, e.g., server device 104, etc. In some implementations, device 700 may be used to implement a client device, a server device, or a combination of the above. Device 700 can be any suitable computer system, server, or other electronic or hardware device as described above.

One or more methods described herein (e.g., 500) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 700 includes a processor 702, a memory 704, and I/O interface 706. Processor 702 can be one or more processors and/or processing circuits to execute program code and control basic operations of the device 700. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 702 may include one or more co-processors that implement neural-network processing. In some implementations, processor 702 may be a processor that processes data to produce probabilistic output, e.g., the output produced by processor 702 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable processor-readable storage medium, such as random access memory (RAM), read-only memory (ROM), Electrically Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 408, machine-learning application 730, price comparison application 712, and application data 714. Other applications may include applications such as a data display engine, web hosting engine, image display engine, notification engine, social networking engine, etc. In some implementations, the machine-learning application 730 and price comparison application 712 can each include instructions that enable processor 702 to perform functions described herein, e.g., some or all of the method of FIG. 6.

The machine-learning application 730 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a price comparison application 712 as described herein and other applications. One or more methods disclosed herein can operate in several environments and platforms, e.g., as a standalone computer program that can run on any type of computing device, as a web application having web pages, as a mobile application (“app”) run on a mobile computing device, etc.

In various implementations, machine-learning application 730 may utilize Bayesian classifiers, support vector machines, neural networks, or other learning techniques. In some implementations, machine-learning application 730 may include a trained model 734, an inference engine 736, and data 732. In some implementations, data 732 may include training data, e.g., data used to generate trained model 734. For example, training data may include any type of data suitable for training a model for price comparison/price adjustment recommendation tasks, such as quantities, prices, thresholds, etc. associated with price comparison and price adjustment recommendations described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 734, training data may include such user data. In implementations where users permit use of their respective user data, data 732 may include permitted data.

In some implementations, data 732 may include collected data such as price comparison look up data, price adjustments, etc. In some implementations, training data may include synthetic data generated for the purpose of training, such as data that is not based on user input or activity in the context that is being trained, e.g., data generated from simulated price comparisons, simulated price adjustments, etc. In some implementations, machine-learning application 730 excludes data 732. For example, in these implementations, the trained model 734 may be generated, e.g., on a different device, and be provided as part of machine-learning application 730. In various implementations, the trained model 734 may be provided as a data file that includes a model structure or form, and associated weights. Inference engine 736 may read the data file for trained model 734 and implement a neural network with node connectivity, layers, and weights based on the model structure or form specified in trained model 734.

Machine-learning application 730 also includes a trained model 734. In some implementations, the trained model 734 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 732 or application data 714. Such data can include, for example, price comparison data, e.g., when the trained model is used for price comparison/price adjustment recommendation functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a price adjustment recommendation, etc. depending on the specific trained model. In some implementations, model form or structure also specifies a number and/or type of nodes in each layer.

In different implementations, the trained model 734 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 734 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 732, to produce a result.

For example, training may include applying supervised learning techniques. In supervised learning, the training data can include a plurality of inputs (e.g., a set of price comparisons) and a corresponding expected output for each input (e.g., a set of corresponding price adjustment recommendations). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner. For example, the model may be trained to identify price differences for price adjustment recommendations.

In another example, a model trained using unsupervised learning may cluster words based on the use of the words in data sources. In some implementations, unsupervised learning may be used to produce knowledge representations, e.g., that may be used by machine-learning application 730. In various implementations, a trained model includes a set of weights, or embeddings, corresponding to the model structure. In implementations where data 732 is omitted, machine-learning application 730 may include trained model 734 that is based on prior training, e.g., by a developer of the machine-learning application 730, by a third-party, etc. In some implementations, trained model 734 may include a set of weights that are fixed, e.g., downloaded from a server that provides the weights.

Machine-learning application 730 also includes an inference engine 736. Inference engine 736 is configured to apply the trained model 734 to data, such as application data 714, to provide an inference. In some implementations, inference engine 736 may include software code to be executed by processor 702. In some implementations, inference engine 736 may specify circuit configuration (e.g., for a programmable processor, for a field programmable gate array (FPGA), etc.) enabling processor 702 to apply the trained model. In some implementations, inference engine 736 may include software instructions, hardware instructions, or a combination. In some implementations, inference engine 736 may offer an application programming interface (API) that can be used by operating system 708 and/or price comparison application 712 to invoke inference engine 736, e.g., to apply trained model 734 to application data 714 to generate an inference.

Machine-learning application 730 may provide several technical advantages. For example, when trained model 734 is generated based on unsupervised learning, trained model 734 can be applied by inference engine 736 to produce knowledge representations (e.g., numeric representations) from input data, e.g., application data 714. For example, a model trained for price comparison/price adjustment suggestion tasks may produce predictions and confidences for given input information about price comparison. A model trained for suggesting price adjustments may produce a suggestion for changing a price based on input price comparison data or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 736.

In some implementations, knowledge representations generated by machine-learning application 730 may be provided to a different device that conducts further processing, e.g., over a network. In such implementations, providing the knowledge representations rather than the images may provide a technical benefit, e.g., enable faster data transmission with reduced cost. In another example, a model trained for price comparison and price adjustment recommendations may produce a price adjustment signal for one or more price comparisons being processed by the model.

In some implementations, machine-learning application 730 may be implemented in an offline manner. In these implementations, trained model 734 may be generated in a first stage and provided as part of machine-learning application 730. In some implementations, machine-learning application 730 may be implemented in an online manner. For example, in such implementations, an application that invokes machine-learning application 730 (e.g., operating system 708, one or more of price comparison application 712 or other applications) may utilize an inference produced by machine-learning application 730, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 734, e.g., to update embeddings for trained model 734.

In some implementations, machine-learning application 730 may be implemented in a manner that can adapt to particular configuration of device 700 on which the machine-learning application 730 is executed. For example, machine-learning application 730 may determine a computational graph that utilizes available computational resources, e.g., processor 702. For example, if machine-learning application 730 is implemented as a distributed application on multiple devices, machine-learning application 730 may determine computations to be carried out on individual devices in a manner that optimizes computation. In another example, machine-learning application 730 may determine that processor 702 includes a GPU with a particular number of GPU cores (e.g., 1000) and implement the inference engine accordingly (e.g., as 1000 individual processes or threads).

In some implementations, machine-learning application 730 may implement an ensemble of trained models. For example, trained model 734 may include a plurality of trained models that are each applicable to same input data. In these implementations, machine-learning application 730 may choose a particular trained model, e.g., based on available computational resources, success rate with prior inferences, etc. In some implementations, machine-learning application 730 may execute inference engine 736 such that a plurality of trained models is applied. In these implementations, machine-learning application 730 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 708 or one or more other applications, e.g., price comparison application 712.

In different implementations, machine-learning application 730 can produce different types of outputs. For example, machine-learning application 730 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 730 may produce an output video with a particular effect applied, e.g., rendered in a comic-book or particular artist's style, when trained model 734 is trained using training data from the comic book or particular artist, etc. In some implementations, machine-learning application 730 may produce an output based on a format specified by an invoking application, e.g. operating system 708 or one or more applications, e.g., price comparison application 712. In some implementations, an invoking application may be another machine-learning application. For example, such configurations may be used in generative adversarial networks, where an invoking machine-learning application is trained using output from machine-learning application 730 and vice-versa.

Any of software in memory 704 can alternatively be stored on any other suitable storage location or computer-readable medium. In addition, memory 704 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. Interfaced devices can be included as part of the device 700 or can be separate and communicate with the device 700. For example, network communication devices, storage devices (e.g., memory and/or database 106), and input/output devices can communicate via I/O interface 706. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 706 can include one or more display devices 720 and one or more data stores 738 (as discussed above). The display devices 720 that can be used to display content, e.g., a user interface of an output application as described herein. Display device 720 can be connected to device 700 via local connections (e.g., display bus) and/or via networked connections and can be any suitable display device. Display device 720 can include any suitable display device such as an LCD, LED, or plasma display screen, CRT, television, monitor, touchscreen, 3-D display screen, or other visual display device. For example, display device 720 can be a flat display screen provided on a mobile device, multiple display screens provided in a goggles or headset device, or a monitor screen for a computer device.

The I/O interface 706 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 7 shows one block for each of processor 702, memory 704, I/O interface 706, and software blocks 708, 712, and 730. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While some components are described as performing blocks and operations as described in some implementations herein, any suitable component or combination of components of environment 100, device 700, similar systems, or any suitable processor or processors associated with such a system, may perform the blocks and operations described.

In some implementations, logistic regression can be used for customization (e.g., customizing price adjustment suggestions based on a user's pattern of price comparison and price adjustment activity). In some implementations, the prediction model can be handcrafted including hand selected price adjustment recommendation thresholds. The mapping (or calibration) from ICA space to a predicted precision within the price comparison/adjustment recommendation space can be performed using a piecewise linear model.

In some implementations, the price comparison/adjustment recommendation system could include a machine-learning model (as described herein) for tuning the system (e.g., selecting price adjustment recommendations and corresponding thresholds) to potentially provide improved accuracy. Inputs to the machine learning model can include ICA labels, an image descriptor vector that describes appearance and includes semantic information about product pricing. Example machine-learning model input can include labels for a simple implementation and can be augmented with descriptor vector features for a more advanced implementation. Output of the machine-learning module can include a prediction of a price adjustment that would improve sales or achieve another goal.

One or more methods described herein (e.g., method 600) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
obtaining a selection of a first entity and a second entity at a user device;
receiving first item information corresponding to a first item being sold by the first entity, wherein the first item information includes a first item identifier, first item price, and first item quantity at a first entity store location;
automatically correlating the first item identifier with a second item identifier associated with a second item that is a non-identically identified item being sold by the second entity that is identical to the first item;
automatically obtaining second item information corresponding to the second item identifier, wherein the second item information includes a second item identifier, a second item price, and a second item quantity at a second entity store location;
displaying the first item information and the second item information juxtaposed in a single user interface display;
in response to selection of a first user interface element, automatically generating a price adjustment recommendation and causing the price adjustment recommendation to be displayed;
in response to selection of a second user interface element, automatically adjusting the price of the first item by sending an electronic message to adjust the price of the first item to a system associated with the first entity; and
in response to selection of third user interface element, automatically generating an electronic message including at least one of price comparison information or automatically generated price adjustment suggestion and causing the electronic message to be transmitted.

2. The computer-implemented method of claim 1, wherein the automatically generated price adjustment recommendation includes one of a price adjustment recommendation to match the first item price with the second item price, a price adjustment recommendation to maintain the first item price a given amount or percentage below the second item price, or a price adjustment recommendation to maintain the first item price above the second item price.

3. The computer-implemented method of claim 1, wherein automatically adjusting the price of the first item includes one of matching the second item price, maintaining the first item price a given amount or percentage below the second item price, or maintaining the first item price above the second item price.

4. The computer-implemented method of claim 1, wherein the second item is an item for which a SKU, a bar code, or other product identifier of the second item does not match a corresponding SKU, bar code, or other product identifier of the first item.

5. The computer-implemented method of claim 1, further comprising performing a price comparison between the price of the first item at the first entity and the price of the second item at the second entity, where the first entity is associated with the user.

6. The computer-implemented method of claim 5, wherein the user is associated with a supplier to the first entity and the second entity is a retail competitor of the first entity.

7. The computer-implemented method of claim 6, wherein the user can perform a price comparison and price adjustment based on price information from the first entity and the second entity.

8. The computer-implemented method of claim 1, wherein the selection of the first entity and the second entity can be determined based on a given geographic area.

9. The computer-implemented method of claim 8, wherein the first entity selection can be set in the settings and the second entity is selected by the user from one or more nearby entities that are presented to the user based on the location of the user device or a location entered by a user.

10. The computer-implemented method of claim 1, wherein the second entity can include more than one entity.

11. The computer-implemented method of claim 1, wherein the user device communicates with a price comparison server to request matching information of the second item at the second entity corresponding to an item number or a barcode number of the first item.

12. The computer-implemented method of claim 11, wherein the matching information includes one or more of manually matched non-identically identified identical products or automatically matched non-identically identified identical products.

13. The computer-implemented method of claim 12, wherein the matching information of the second item includes one or more of a barcode number, an item number, or other information used by the second entity to identify the non-identically identified identical product.

14. The computer-implemented method of claim 1, where automatically obtaining second item information includes the user device or a server accessing a publicly available source of information to automatically obtain electronic information that indicates a current price and other information related to the second item for which price comparison is being performed.

15. The computer-implemented method of claim 14, further comprising extracting one or more of price or quantity information from a website of the second entity and providing the price or quantity information for display to the user.

16. The computer-implemented method of claim 14, wherein price and quantity information of the second item is obtained through an API in communication with an ecommerce website, or by accessing competitor data that has been manually or automatically entered.

17. The computer-implemented method of claim 1, wherein the price adjustment can be an automatically generated adjustment or a manually input adjustment.

18. The computer-implemented method of claim 1, wherein if the first entity and the second entity have the same quantities on hand of the first item and second item respectively, and if a price of the first item at the first entity is higher than the price of the second item form the second entity, the automatically generated price adjustment recommendation is to match or be lower than the second item price at the second entity.

19. The computer-implemented method of claim 1, wherein if the quantity of the second item at the second entity is lower than the quantity of the first item at the first entity or zero and the price of the second item is lower than the price of the first item at the first entity, the automatically generated recommendation is to keep the price the same or increase the price of the first item at the first entity.
